(19) United States
(12) Patent Application Publication
(10) Pub. No.: US 2009/0323761 A1
(43) Pub. Date: Dec. 31, 2009

(54) Water temperature indicating device for bath, shower and the like

(76) Inventor: Pi Kuang Tsai, Taichung (TW)

Correspondence Address: CHARLES E. BAXLEY, ESQUIRE, 90 JOHN STREET, SUITE 309, NEW YORK, NY, 10038, US

(21) Appl. No.: 12/215,166

(22) Filed: Jun. 25, 2008

(51) Int. Cl. G01K 13/02

(52) U.S. Cl. 374/148; 374/E13.006

(57) ABSTRACT

A water temperature indicating device includes a tube having a port which includes a compartment formed by a bottom wall, a housing attached to the coupler, a circuit board disposed in the housing and has a light element, a processor device is attached to the circuit board for actuating the light element, a sensing device attached to the bottom wall of the coupler for detecting a water temperature and for sending the detected water temperature to the processor device and to operate the light element, and a water operated switching device is used for actuating the processor device to operate the light element with the water flowing through the chamber of the tube.

### BACKGROUND OF THE INVENTION

1. Field of the Invention

The present invention relates to a water temperature indicating device for bath, shower and the like, and more particularly to a water temperature indicating device including a structure for easily and readily attached to the shower device without changing the structure of the shower device.

2. Description of the Prior Art

Typical water temperature indicating devices for hand showers comprise a temperature sensitive means or thermometer including a bimetallic element extended into a water flow passage for sensing or detecting the water temperature, and a temperature marker for indicating the water temperature and for preventing the user from being hurt by the hot water inadvertently.

For example, U.S. Pat. No. 4,161,881 to Raz discloses one of the typical hand shower and temperature indicating unit comprise a shower head including a water chamber, and a temperature sensitive means or thermometer positioned inside the water chamber adjacent the opposite surface of the water chamber.

However, the temperature sensitive means or thermometer may be provided for use with the typical hand shower and temperature indicating unit only, but may not be used with the other hand shower or shower nozzles.

U.S. Pat. No. 4,030,360 to Fortune, and U.S. Pat. No. 4,743,120 to Bowen disclose two further typical shower water temperature sensing or measuring instrument for mounting on existing water faucets or showers to provide a ready visible indication of the temperature of the water flowing through the faucet or shower.

However, the typical shower water temperature sensing or measuring instrument may only be used to sense or to measure the water temperature, but may not be used to clearly show or indicate the temperature of the water flowing through the faucet or shower such that the user may also have a good chance to be hurt by the hot water inadvertently. In addition, the typical hand shower and temperature indicating units or the typical shower water temperature sensing or measuring instruments are controlled manually, but may not be controlled by the water flowing through the water receiving pipes or tubes of the typical hand shower and temperature indicating units or of the typical shower water temperature sensing or measuring instruments.

The present invention has arisen to mitigate and/or obviate the afore-described disadvantages of the conventional water temperature indicating devices.

### SUMMARY OF THE INVENTION

The primary objective of the present invention is to provide a water temperature indicating device including a structure for easily and readily attached to the shower device without changing the structure of the shower device.

In accordance with one aspect of the invention, there is provided a water temperature indicating device comprising a tube including a chamber formed therein, and including an inlet for receiving water, and including an outlet, and including a port communicating with the chamber of the tube, a coupler attached to the port of the tube and including a compartment formed therein and defined by a bottom wall, a housing attached to the coupler and including a chamber formed therein, a circuit board disposed in the chamber of the housing and including a light element, a processor device attached to the circuit board and electrically coupled to the light element for selectively actuating and operating the light element to generate a light, a sensing device attached to the bottom wall of the coupler for detecting a water temperature of the water flowing through the chamber of the tube, and the sensing device being electrically coupled to the processor device for sending a detected water temperature to the processor device and for selectively actuating the processor device to operate the light element, and a water operated switching device for selectively actuating the processor device to operate the light element with the water flowing through the chamber of the tube.

The coupler includes a casing extended therefrom and engaged into the chamber of the tube for engaging with the water flowing through the chamber of the tube.

The switching device includes a magnetic switch attached to the bottom wall of the coupler and electrically coupled to the processor device, and a magnetic member slidably received in the casing and movable toward and away from the magnetic switch and for selectively actuating the magnetic switch to operate the processor device.

The casing includes a space formed therein for receiving the water flowing through the chamber of the tube, and a follower slidably received in the space of the casing, and the magnetic member is attached to the follower.

The casing includes a stop formed therein for selectively engaging with the follower and for limiting the follower to slide relative to the casing. The follower includes at least one finger extended therefrom for engaging with the stop and for guiding the follower to slide relative to the casing.

A spring biasing device or member may further be provided and disposed between the stop and the follower for biasing or forcing the follower away from the stop. The casing includes a retaining ring attached thereto for engaging with the follower and for limiting the follower to slide relative to the casing.

The light element may be provided for generating a red light and/or a yellow light and/or a green light and/or the combination of the lights. The circuit board includes a buzzer electrically coupled to the processor device for generating sounds.

The housing includes an upper wall having an opening formed therein for receiving the light element. The housing includes a cover attached to the housing and made of transparent materials for allowing the light to be seen through the cover.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a water temperature indicating device in accordance with the present invention;

FIG. 2 is a perspective view of the water temperature indicating device;

FIG. 3 is an exploded view of the water temperature indicating device;

FIG. 4 is a cross sectional view of the water temperature indicating device taken along lines 4-4 of FIG. 2;

FIG. 5 is an enlarged partial cross sectional view of the water temperature indicating device as shown in FIG. 4;

FIG. 6 is a cross sectional view similar to FIG. 4, illustrating the operation of the water temperature indicating device;

FIG. 7 is an enlarged partial cross sectional view of the water temperature indicating device as shown in FIG. 6; and

FIGS. 8, 9, 10, 11, 12 are perspective views similar to FIG. 1, illustrating the other applications or the other arrangements of the water temperature indicating device.

### DETAILED DESCRIPTION OF THE PREFERRED EMBODIMENT

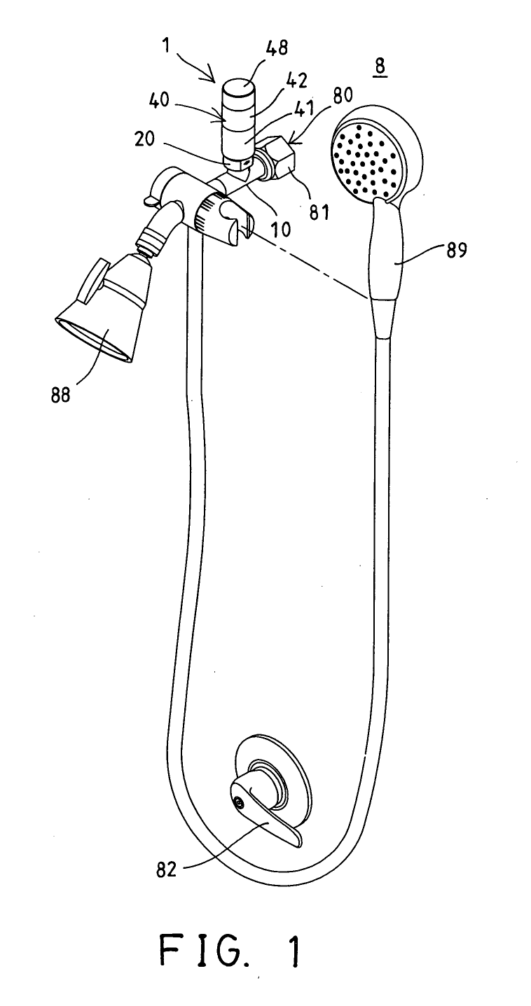

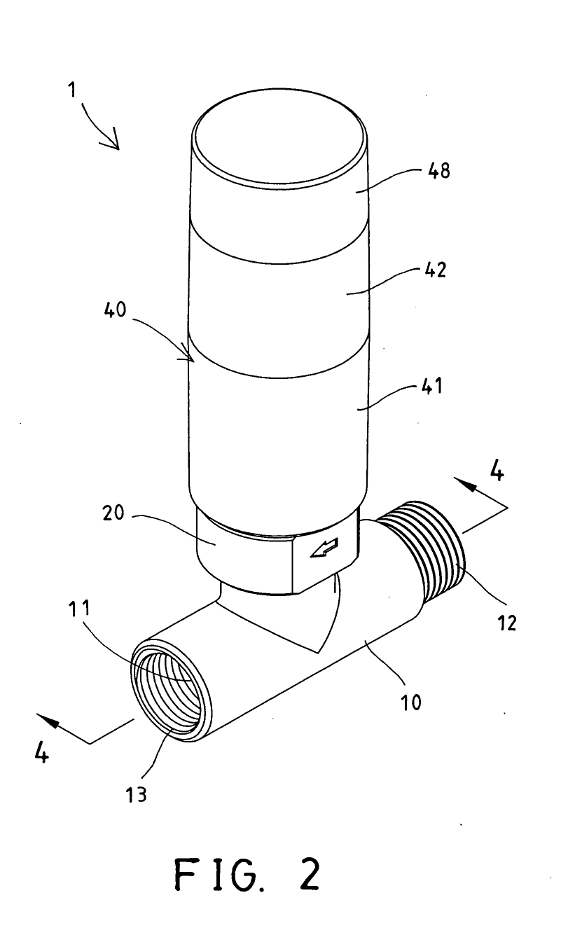

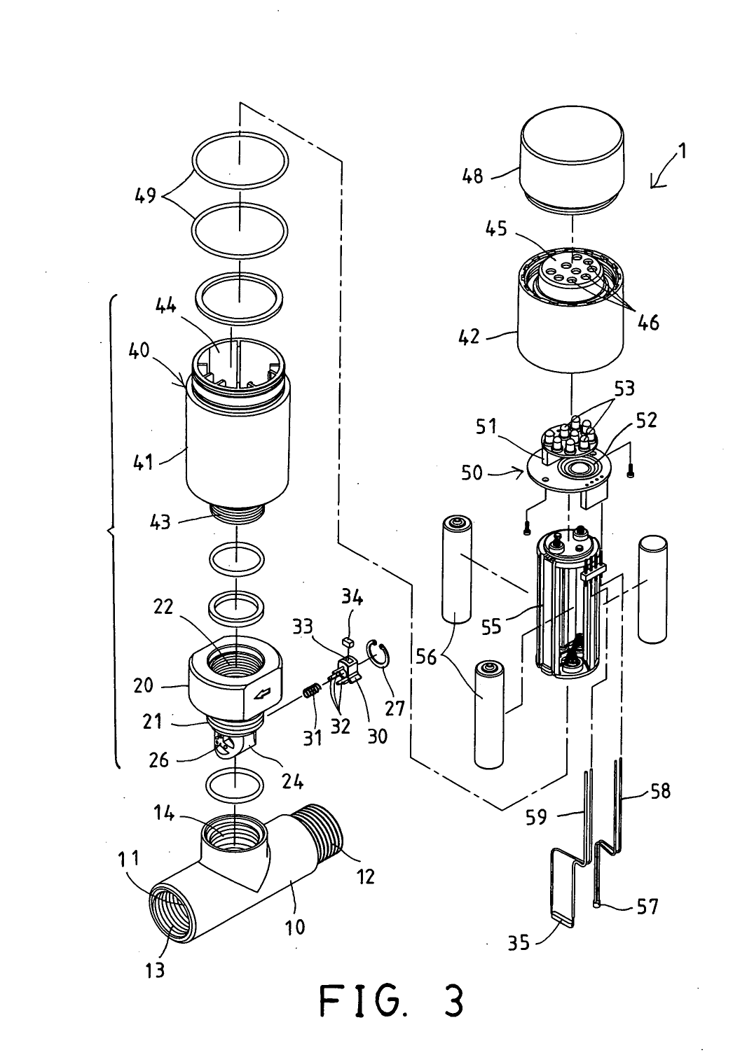

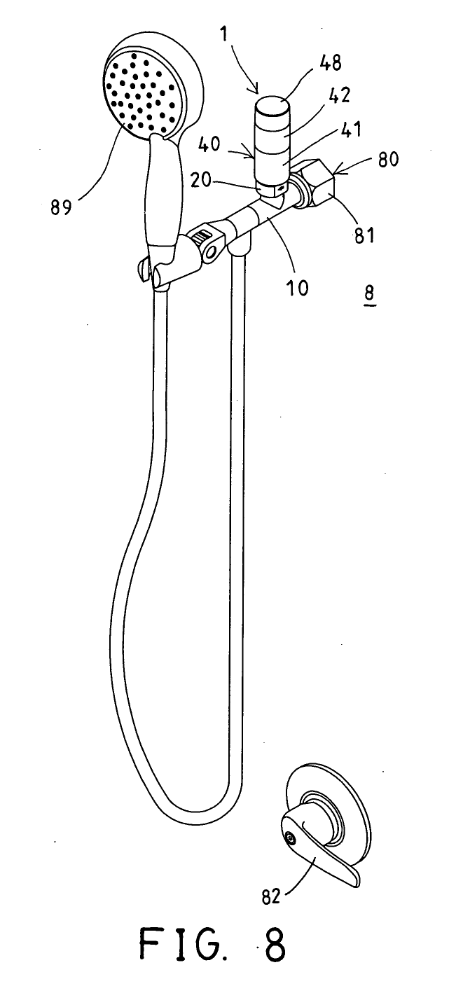

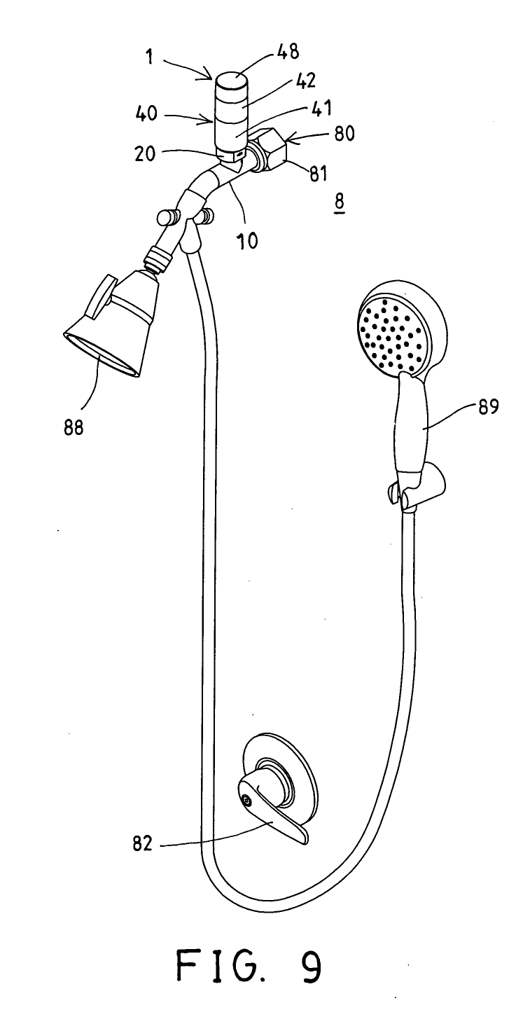

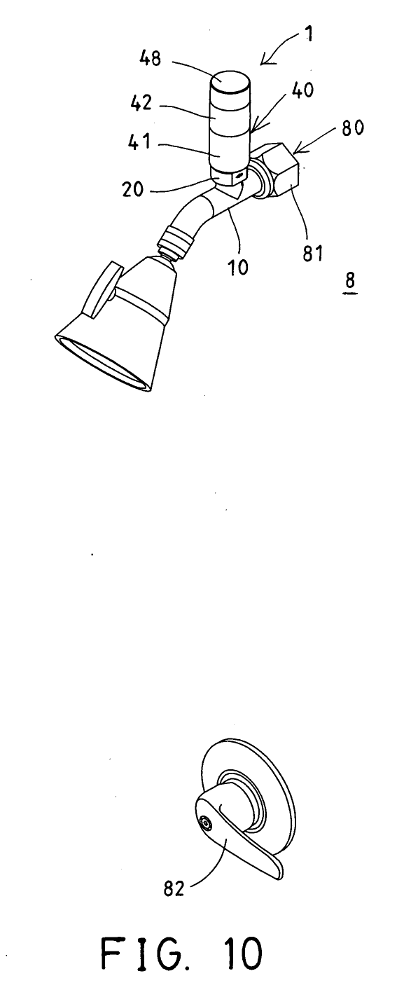

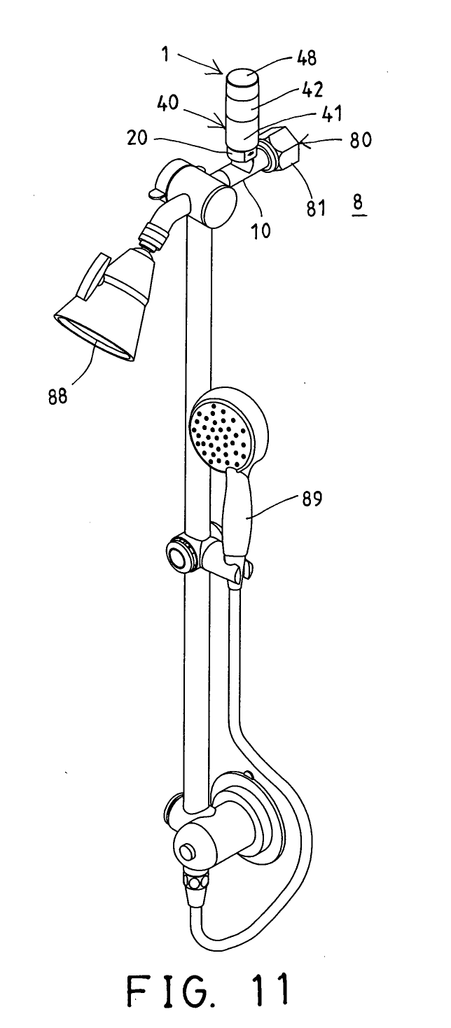

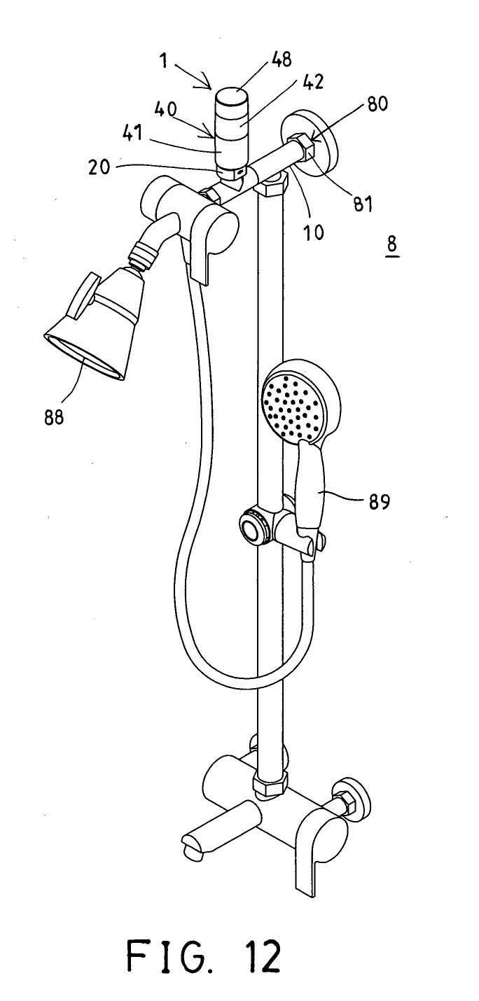

Referring to the drawings, and initially to FIGS. 1 and 8-12, a water temperature indicating device 1 in accordance with the present invention comprises a tube 10 coupled to a water supplying pipe 80 that is attached to or engaged in a wall 8 of a bathroom with a bracket or fitting 81 for receiving the water from the water supplying pipe 80, and a control device 82 (FIGS. 1 and 8-10) may be attached to the wall 8 for controlling the water to flow through the water supplying pipe 80 and the tube 10. For example, as shown in FIGS. 2-4, the tube 10 includes a bore or water flowing passage or chamber 11 formed therein, and includes one end or inlet 12 coupled to the water supplying pipe 80, and includes another end or opposite end or outlet 13 for coupling to one or more shower nozzles 88, 89 (FIGS. 1 and 8-12), and includes a port 14 communicating with the chamber 11 of the tube 10.

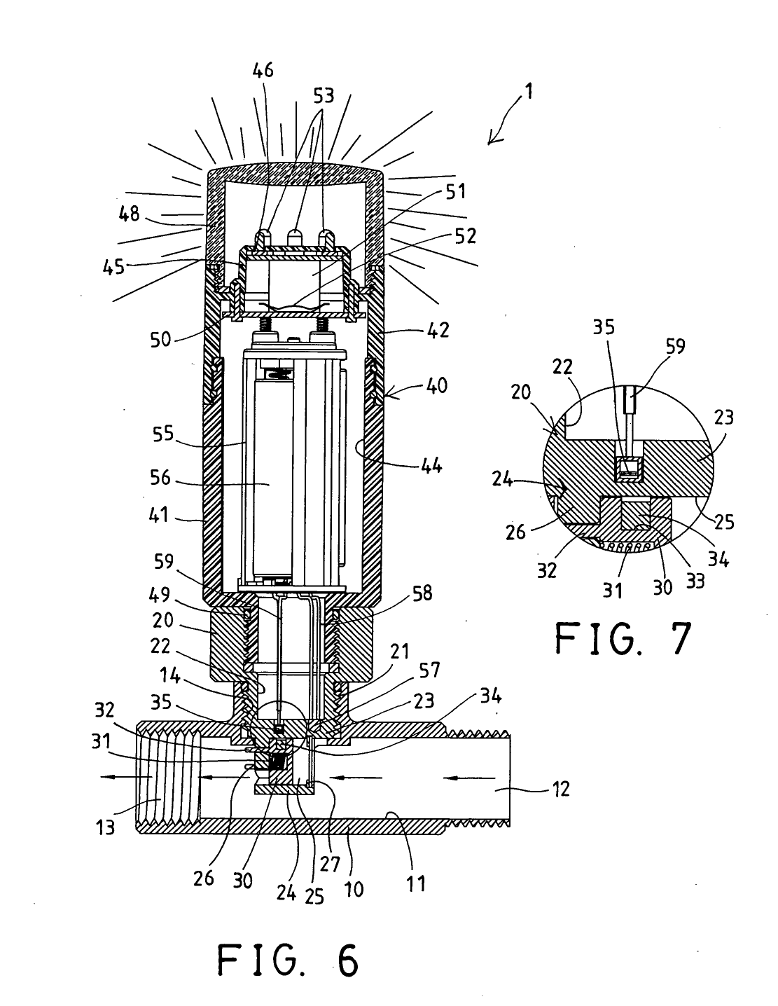

As also shown in FIGS. 2-4, the water temperature indicating device 1 includes a coupler 20 attached to the port 14 of the tube 10 with a retaining ring, an outer thread or a threading engagement 21, the coupler 20 includes a compartment 22 formed therein, and formed or defined by a bottom wall 23 such that the compartment 22 of the coupler 20 is formed as a blind hole, and includes a casing 24 extended downwardly therefrom or extended downwardly from the bottom wall 23 and engaged into the chamber 11 of the tube 10 for engaging with the water flowing through the chamber 11 of the tube 10 (FIG. 6). The casing 24 includes a space 25 formed therein for receiving the water flowing through the chamber 11 of the tube 10, and includes a stop, such as a spider shaped or perforated stop 26 formed therein, such as formed in the rear portion thereof and located closer to the outlet 13 of the tube 10.

A slide or follower 30 is slidably received in the space 25 of the casing 24 and is arranged to be pushed or forced toward the stop 26 by the water flowing through the chamber 11 of the tube 10, and a spring biasing means or member 31 is disposed or engaged between the stop 26 and the follower 30 for biasing or forcing the follower 30 away from the stop 26, or toward the front portion of the casing 24, and a clamping ring or retaining ring 27 is attached to or engaged with the front portion of the casing 24 for engaging with the follower 30, and for limiting the sliding movement of the follower 30 relative to the casing 24, and for preventing the follower 30 from being disengaged from the casing 24. The follower 30 may include one or more (such as three) fingers 32 extended outwardly therefrom for slidably engaging with the stop 26 and for guiding the follower 30 to stably and smoothly slide relative to the casing 24.

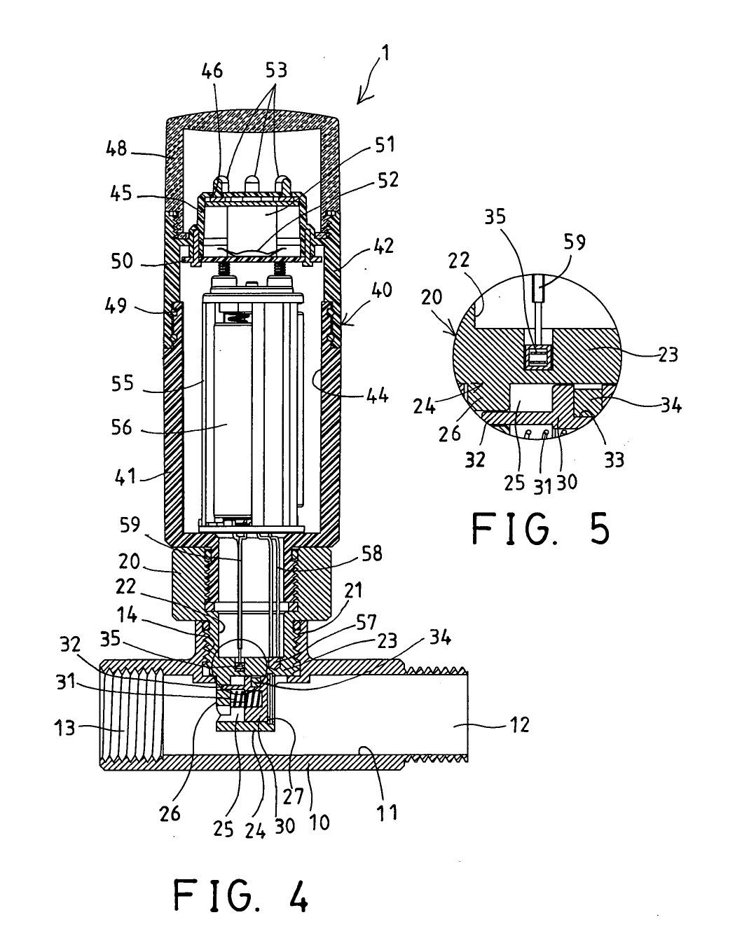

The follower 30 further includes a cavity 33 formed therein, such as formed in the upper portion thereof for receiving or engaging with a magnet or magnetic attractive member 34, a magnetic switch 35 is attached to or engaged into the bottom wall 23 of the coupler 20 for selectively engaging with the magnetic member 34 and for being selectively actuated or operated by the magnetic member 34. For example, the magnetic switch 35 may be selectively actuated or operated by the magnetic member 34 when the follower 30 and the magnetic member 34 are moved toward the stop 26 by the water flowing through the chamber 11 of the tube 10 (FIGS. 6, 7), and will not be actuated or operated by the magnetic member 34 when the follower 30 and the magnetic member 34 are moved away from the stop 26 by the spring biasing member 31 (FIGS. 4, 5).

A housing 40 includes one or more (such as two) housing members 41, 42 detachably secured together and attached to the coupler 20 with a retaining ring, an outer thread or another threading engagement 43, and includes a chamber 44 formed therein, and includes an upper wall 45 provided or formed in the upper housing member 42, and includes a number of openings 46 formed in the upper wall 45 and communicating with the chamber 44 of the housing 40, and includes a hood or cover 48 attached to the upper portion of the housing 40 and made of transparent or semi-transparent materials, and includes a number of gaskets or sealing rings 49 disposed or engaged between the housing 40 or the housing members 41, 42 and the coupler 20 and the tube 10 for making an air tight or a water tight seal therebetween.

A circuit board 50 is secured to the housing 40, such as secured to the upper wall 45 of the upper housing member 42, and includes a microprocessor or processor device 51 attached to the circuit board 50, and includes a speaker or buzzer 52 electrically coupled to the processor device 51 for generating sounds, such as the warning sounds, and includes a light device having a number of light bulbs or light elements 53 electrically coupled to the processor device 51 and extended or engaged through the openings 46 of the upper wall 45 of the housing 40 for generating lights and for allowing the lights to be seen through the transparent or semi-transparent cover 48. It is preferable that the light elements 53 may generate the lights of different color for indicating different water temperatures, for example.

A casing 55 is attached or secured to the housing 40, and disposed in the chamber 44 of the housing 40 for receiving an energizing means or one or more batteries 56, and the batteries 56 are electrically coupled to the processor device 51 and/or the light elements 53 and/or the buzzer 52 for energizing the same. A thermometer or temperature sensitive means or sensing device 57 is attached to or engaged into the bottom wall 23 of the coupler 20 for detecting or sensing the water temperature of the water flowing through the chamber 11 of the tube 10, and is electrically coupled to the processor device 51 with electric wires or cables 58 for sending or transmitting the detected water temperature to the processor device 51 which may then actuate or operate the buzzer 52 to generate the sounds and/or may actuate or operate the light elements 53 to generate the lights. The magnetic switch 35 may also be electrically coupled to the processor device 51 with electric wires or cables 59 for actuating the processor device 51 to selectively operate the light elements 53 and/or the buzzer 52.

In operation, as shown in FIGS. 4 and 5, when no water is supplied or flew through the chamber 11 of the tube 10, the spring biasing means or member 31 may bias or force the follower 30 away from the stop 26, or toward the front portion of the casing 24, and may bias or move the magnetic member 34 away from the stop 26 and the magnetic switch 35, such that the magnetic switch 35 may not be actuated or operated by the magnetic member 34 at this moment. On the contrary, as shown in FIGS. 6 and 7, when the water is supplied or flew through the chamber 11 of the tube 10, the water flowing through the chamber 11 of the tube 10 may force or move the follower 30 onto the spring biasing member 31 and may move the magnetic member 34 toward the magnetic switch 35 in order to selectively actuate or operate the magnetic switch 35 and so as to actuate the processor device 51 to selectively operate the light elements 53 and/or the buzzer 52. The magnetic member 34 and the magnetic switch 35 may act as a water operated switching means for selectively actuating the processor device 51 to operate the light elements 53 and/or the buzzer 52.

It is to be noted that some of the light elements 53 may generate red lights, the other light elements 53 may generate yellow lights, and the further light elements 53 may generate green lights, and the processor device 51 may actuate or operate the light elements 53 generate the mixed lights of different colors, such as the white lights, the blue lights, the light blue lights, the purple lights and the like with the red lights and the yellow lights and the green lights. The mixed lights of different color may be used to indicate different water temperatures, for example, or may be used to generate dancing lights for entertainment purposes. It is preferable that the light elements 53 generate the red lights to indicate that the water temperature is over a predetermined safe value, in order to prevent the user from being hurt by the hot water inadvertently. It is further to be noted that the water temperature indicating device 1 in accordance with the present invention may be easily and readily attached to various kinds of shower devices without changing the structure of the shower devices.

Accordingly, the water temperature indicating device includes a structure for easily and readily attached to the shower device without changing the structure of the shower device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water temperature indicating device comprising:
a tube including a chamber formed therein, and including an inlet for receiving water, and including an outlet, and including a port communicating with said chamber of said tube,
a coupler attached to said port of said tube and including a compartment formed therein and defined by a bottom wall,
a housing attached to said coupler and including a chamber formed therein,
a circuit board disposed in said chamber of said housing and including a light element,
a processor device attached to said circuit board and electrically coupled to said light element for selectively actuating and operating said light element to generate a light,
a sensing device attached to said bottom wall of said coupler for detecting a water temperature of the water flowing through said chamber of said tube, and said sensing device being electrically coupled to said processor device for sending a detected water temperature to said processor device and for selectively actuating said processor device to operate said light element, and
a water operated switching means for selectively actuating said processor device to operate said light element with the water flowing through said chamber of said tube.

2. The water temperature indicating device as claimed in claim 1, wherein said coupler includes a casing extended therefrom and engaged into said chamber of said tube for engaging with the water flowing through said chamber of said tube.

3. The water temperature indicating device as claimed in claim 2, wherein said switching means includes a magnetic switch attached to said bottom wall of said coupler and electrically coupled to said processor device, and a magnetic member slidably received in said casing and movable toward and away from said magnetic switch and for selectively actuating said magnetic switch to operate said processor device.

4. The water temperature indicating device as claimed in claim 3, wherein said casing includes a space formed therein for receiving the water flowing through said chamber of said tube, and a follower slidably received in said space of said casing, and said magnetic member is attached to said follower.

5. The water temperature indicating device as claimed in claim 4, wherein said casing includes a stop formed therein for selectively engaging with said follower and for limiting said follower to slide relative to said casing.

6. The water temperature indicating device as claimed in claim 5, wherein said follower includes at least one finger extended therefrom for engaging with said stop and for guiding said follower to slide relative to said casing.

7. The water temperature indicating device as claimed in claim 5, wherein a spring biasing member is disposed between said stop and said follower for biasing or forcing said follower away from said stop.

8. The water temperature indicating device as claimed in claim 4, wherein said casing includes a retaining ring attached thereto for engaging with said follower and for limiting said follower to slide relative to said casing.

9. The water temperature indicating device as claimed in claim 1, wherein said light element is provided for generating a red light.

10. The water temperature indicating device as claimed in claim 1, wherein said light element is provided for generating a yellow light.

11. The water temperature indicating device as claimed in claim 1, wherein said light element is provided for generating a green light.

12. The water temperature indicating device as claimed in claim 1, wherein said circuit board includes a buzzer electrically coupled to said processor device for generating sounds.

13. The water temperature indicating device as claimed in claim 1, wherein said housing includes an upper wall having an opening formed therein for receiving said light element.

14. The water temperature indicating device as claimed in claim 1, wherein said housing includes a cover attached to the housing and made of transparent materials for allowing the light to be seen through said cover.
